(19) United States
(12) Patent Application Publication
(10) Pub. No.: US 2007/0145254 A1
(43) Pub. Date: Jun. 28, 2007

(54) Packaging method for an assembly of image-sensing chip and circuit board

(76) Inventor: Feng Chen, Bothell, WA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/318,875

(22) Filed: Dec. 28, 2005

(51) Int. Cl. H01J 5/02

(52) U.S. Cl. 250/239

(57) ABSTRACT

A packaging method for an assembly of image-sensing chip and circuit board, including steps of: preparing a module circuit board having several leads and module circuits on a surface, an image-sensing chip being mounted on the circuit board, wires being bonded from the image-sensing chip to the leads to electrically connect the image-sensing chip with the circuit board; adhering a lens holder onto the circuit board above the image-sensing chip to enclose the image-sensing chip; mounting a lens unit having at least one lens on the lens holder and adjusting the focal length between the lens and the image-sensing chip; and airtight filling glue material to the joint between the lens unit and the lens holder to constantly fix the lens unit with the lens holder and complete the package of an image sensing module.

### BACKGROUND OF THE INVENTION

The present invention is related to a packaging method for an assembly of image-sensing chip and circuit board. A lens unit is directly disposed above the image-sensing chip to enclose the same instead of the conventional glass board for protecting the image-sensing chip. On one hand, the possibility of contamination of the lens unit during packaging procedure is minified and on the other hand, the image sensing module still keeps the original image sensing function. Also, the packaging cost is lowered.

FIG. 3 shows a conventional packaging method for image pickup module. An image-sensing chip 6 is mounted on a circuit board 7 having multiple leads 71 on a surface. The leads 71 are connected with the module circuit 72. By means of wire layout, the image-sensing chip 6 is electrically connected with the leads 71. A bank 81 is adhered around the leads 71 and a glass board 82 is airtight adhered to the bank 81 to ensure electric connection between the image-sensing chip 6 and the circuit board 7. In this state, the image sensor is preliminarily packaged. Referring to FIG. 4, after preliminarily packaged, the image sensor is transferred to next factory for further installing a lens unit 9 on the circuit board 7. The tens 91 of the lens unit 9 is positioned above the image-sensing chip 6 and the glass board 82 to complete the package of the image sensing module B. Finally, as shown in FIG. 5, the quality. and image formation effect of the sensing module B are tested.

However, when tested, it is often found that the ratio of good products of the image sensing module B is unsatisfactory. This is because the surface of the glass board 82 is contaminated by dust which interferes with the image formation signal received by the image-sensing chip 6. The contamination most likely takes place during transfer of the image sensor to the next factory. This leads to descent of the ratio of good products.

The factory often needs to bear the loss resulting from the defective products. Therefore, the factory may suffer a loss. Moreover, the image sensing module is tested after totally packaged. Therefore, the defective products can be hardly found during packaging procedure.

Therefore, it is tried by the applicant to improve the package of the image sensor so as to minimize the possibility of contamination of the image sensor during transfer. Also, it is tried by the applicant to simplify the packaging procedure and shorten quality control time of the image sensor so as to enhance production efficiency and lower packaging cost.

### SUMMARY OF THE INVENTION

It is therefore a primary object. of the present invention to provide a packaging method for an assembly of image-sensing chip and circuit board. A lens holder is directly disposed above the image-sensing chip to enclose the same instead of the step of forming the bank around the image-sensing chip and the step of adhering the glass board to the bank in the conventional packaging method. Therefore, the packaging method is simplified and the glass board is omitted. Accordingly, the possibility of contamination of the lens holder is minified and the ratio of good products is enhanced. Also, the packaging cost is lowered.

According to the above object, the packaging method for the assembly of image-sensing chip and circuit board of the present invention includes steps of:

preparing a module circuit board having several leads and module circuits on a surface, an image-sensing chip being mounted on the circuit board, wires being bonded from the image-sensing chip to the leads to electrically connect the image-sensing chip with the circuit board;

adhering a lens holder onto the circuit board above the image-sensing chip to enclose the image-sensing chip;

disposing one or more lens into an axial cavity of a cylindrical frame, glue material being filled into a gap between the lens and a wall of the cavity to tightly associate the lens with the frame to form a lens unit, then, the lens unit being screwed into a thread hole of upper end of the lens holder with the lens aligned with the image-sensing chip, then, the lens unit being screwed to adjust the longitudinal position thereof and thus adjust the focal length into the image formation focal length between the lens and the image-sensing chip, whereby an optimal image formation effect of the image-sensing chip is achievable; and

airtight filling glue material to the joint between the lens unit and the lens holder to constantly fix the lens unit with the lens holder and complete the package of an image sensing module.

The present invention can be best understood through the following description and accompanying drawings wherein:

### BRIEF DESCRIPTION OF THE DRAWINGS

FIG. 1 is a flow chart of the packaging method of the present invention;

FIG. 2 is a sectional view of the image sensing module of the present invention;

FIG. 3 is a flow chart of a conventional packaging method of the image sensor;

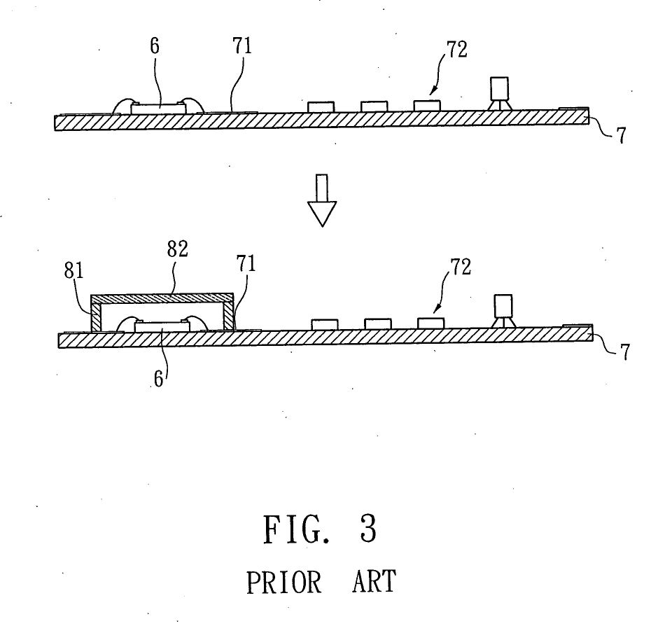

FIG. 4 is a flow chart of a conventional manufacturing method of the image sensing module; and

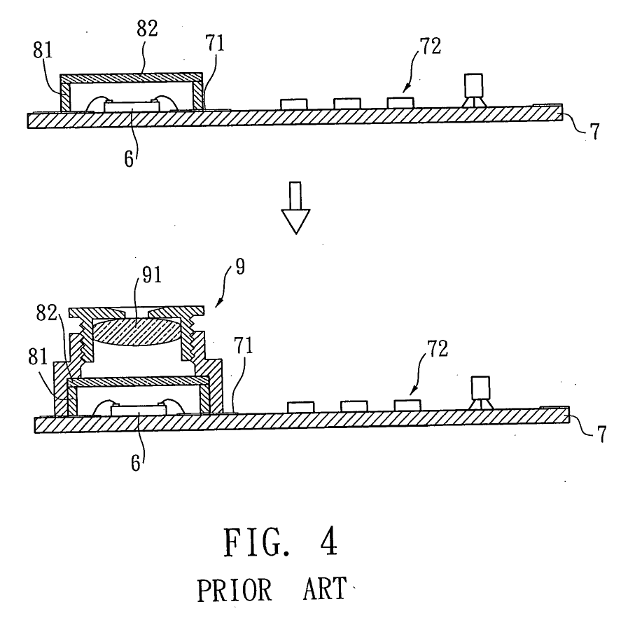

FIG. 5 is a sectional view of the conventional image sensing module.

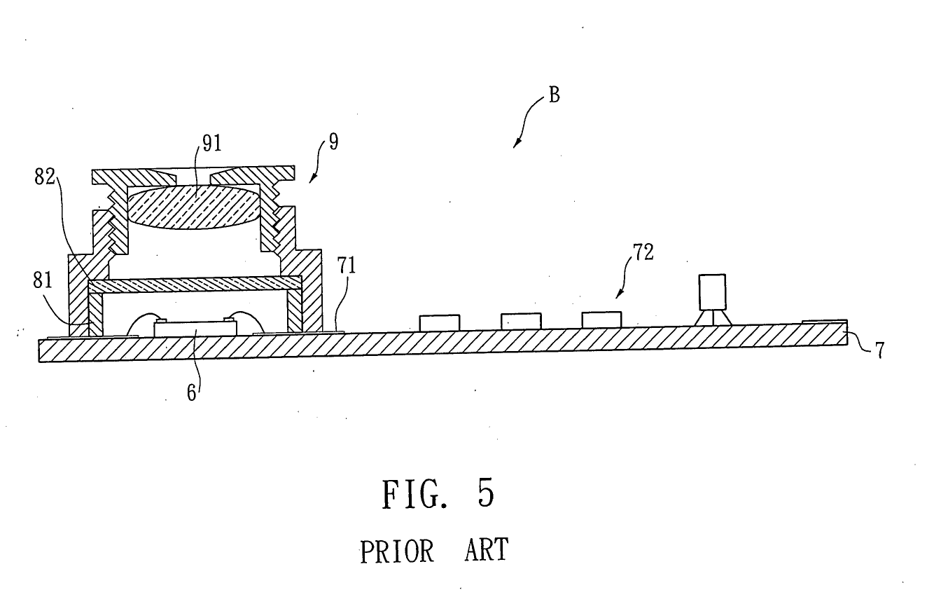

### DETAILED DESCRIPTION OF THE PREFERRED EMBODIMENTS

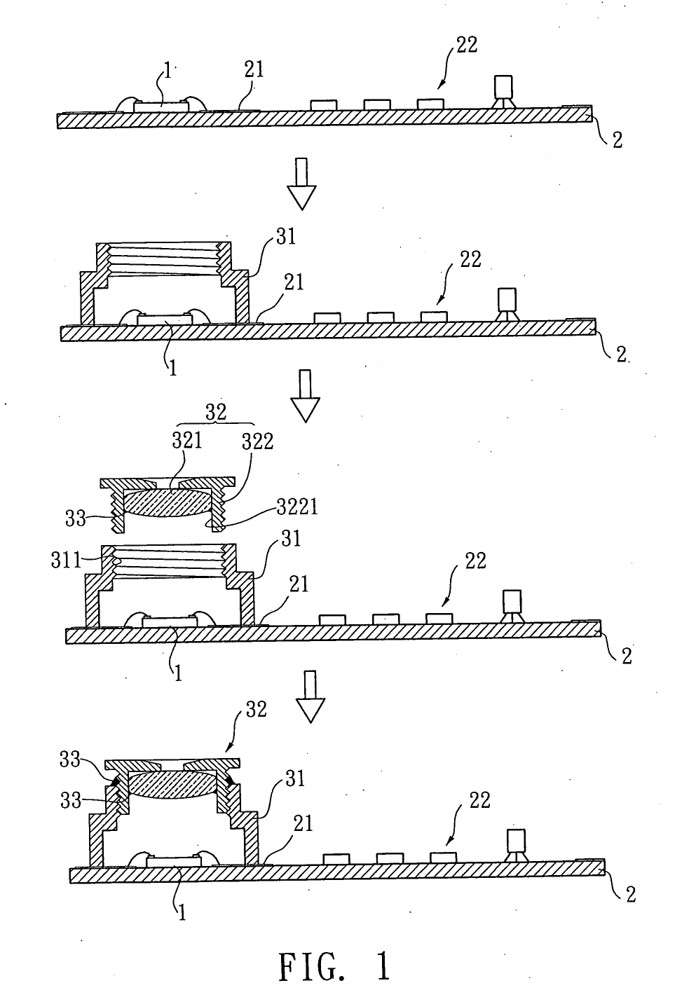

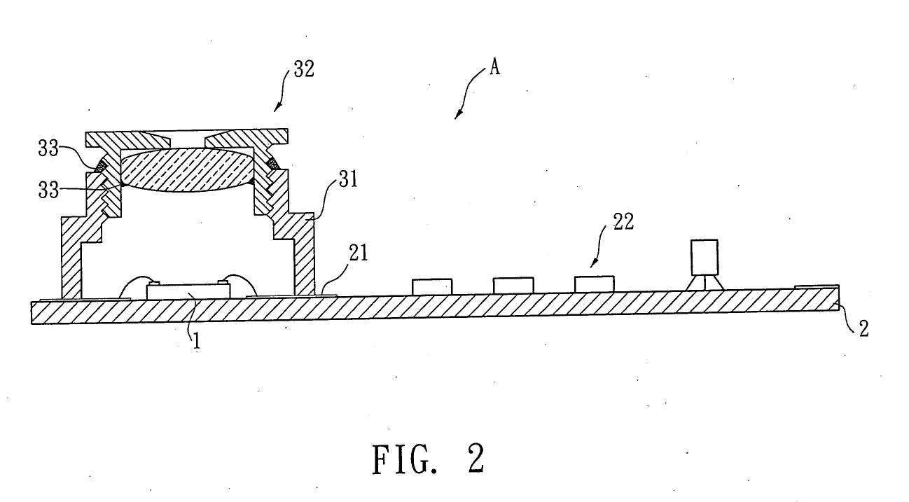

Please refer to FIGS. 1 and 2. The packaging method for the assembly of image-sensing chip and circuit board of the present invention includes steps of:

preparing a module circuit board 2 having several leads 21 and module circuits 22 on a surface, an image-sensing chip 1 being mounted on the circuit board 2, wires being bonded from the image-sensing chip 1 to the leads 21 to electrically connect the image-sensing chip 1 with the circuit board 2;

adhering a lens holder 31 onto the circuit board 2 above the image-sensing chip 1 to enclose the image-sensing chip 1;

disposing one or more lens 321 into an axial cavity 3221 of a cylindrical frame 322, glue material 33 being filled into a gap between the lens 321 and a wall of the cavity 3221 to tightly associate the lens 321 with the frame 322 to form a lens unit 32, then, the lens unit 32 being screwed into a thread hole 311 of upper end of the lens holder 31 with the lens 321 aligned with the image-sensing chip 1, then, the lens unit 32 being screwed to adjust the longitudinal position thereof and thus adjust the focal length into the image formation focal length between the lens 321 and the image-sensing chip 1, whereby an optimal image formation effect of the image-sensing chip 1 is achievable; and

airtight filling glue material 33 to the joint between the lens unit 32 and the lens holder 31 to constantly fix the lens unit 32 with the lens holder 31 and complete the package of the image sensing module A. The various performances of the image sensing module A can be simultaneously tested.

According to the above arrangement, the lens holder 31 is directly disposed above the image-sensing chip 1 to enclose the same instead of the step of forming the bank around the image-sensing chip 1 and the step of adhering the glass board to the bank in the conventional packaging method. That is, the circumference of the lens holder 31 directly serves as the bank surrounding the image-sensing chip 1. Also, the lens 321 of the lens unit 32 is used instead of the glass board used in the conventional packaging method to achieve the airtight effect without ill affection. The packaging method is simplified and the glass board is omitted so that the same factory can accomplish the package of the image sensing module A. On one hand, the possibility of contamination of the lens holder 31 is minified and on the other hand, the image sensing module A still keeps the original image sensing-function. In case the surface of the lens 321 of the lens unit 32 is stained by dust or scraped, an operator can easily find this and replace the lens unit 32 with a new one when adjusting the focal length. Therefore, it is no more necessary to deem such image sensing module A as a defective product. Accordingly, the present invention not only simplifies the packaging procedure, but also enhances the production efficiency and the ratio of good products. Also, the packaging cost is lowered.

The above embodiments are only used to illustrate the present invention, not intended to limit the scope thereof. Many modifications of the above embodiments can be made without departing from the spirit of the present invention.

What is claimed is:

1. A packaging method for an assembly of image-sensing chip and circuit board, comprising steps of:
preparing a module circuit board having several leads and module circuits on a surface, an image-sensing chip being mounted on the circuit board, wires being bonded from the image-sensing chip to the leads to electrically connect the image-sensing chip with the circuit board;
adhering a lens holder onto the circuit board above the image-sensing chip to enclose the image-sensing chip;
disposing one or more lens into an axial cavity of a cylindrical frame, glue material being filled into a gap between the lens and a wall of the cavity to tightly associate the lens with the frame to form a lens unit, then, the lens unit being screwed into a thread hole of upper end of the lens holder with the lens aligned with the image-sensing chip, then, the lens unit being screwed to adjust the longitudinal position thereof and thus adjust the focal length into the image formation focal length between the lens and the image-sensing chip, whereby an optimal image formation effect of the image-sensing chip is achievable; and
airtight filling glue material to the joint between the lens unit and the lens holder to constantly fix the lens unit with the lens holder and complete the package of an image sensing module.
